(19) United States
(12) Patent Application Publication
(10) Pub. No.: US 2002/0084336 A1
(43) Pub. Date: Jul. 4, 2002

(54) Apparatus for preventing moisture on the rear window glass of an automobile

(76) Inventor: Jun-Sik Shin, Kyoungki-do (KR)

Correspondence Address: BIRCH STEWART KOLASCH & BIRCH, PO BOX 747, FALLS CHURCH, VA, 22040-0747, US

(21) Appl. No.: 09/966,057

(22) Filed: Oct. 1, 2001

(30) Foreign Application Priority Data
Dec. 29, 2000 (KR) 2000-85243

(51) Int. Cl. G05D 21/00; B01F 3/02

(52) U.S. Cl. 236/44 R

(57) ABSTRACT

The present invention relates to an apparatus for preventing moisture on the rear window of an automobile and more particularly, to the apparatus for preventing moisture from being condensed on the rear window by collecting moisture which has polarity and moves downward on the rear window at a passage and then allowing the collected moisture to drain through the passage to the bottom of the rear window when the inside humidity of an automobile is above a predetermined limit, wherein the static-electricity generating means, selectively operated by both a humidity sensor and a switch, is mounted along the edges of the rear window, the passage is formed along the static-electricity generating means, and the humidity sensor is installed inside an automobile.

### FIELD OF THE INVENTION

The present invention relates to an apparatus for preventing moisture on the rear window of an automobile and more particularly, to the apparatus for preventing moisture from being condensed on the rear window by collecting moisture which has polarity and moves downward on the rear window at a passage and then allowing the collected moisture to drain through the passage to the bottom of the rear window when the inside humidity of an automobile is above a predetermined limit, wherein the static-electricity generating means, selectively operated by both a humidity sensor and a switch, is mounted along the edges of the rear window, the passage is formed along the static-electricity generating means, and the humidity sensor is installed inside an automobile.

### BACKGROUND OF THE INVENTION

Generally, while driving in high temperature and humidity on a rainy or cloudy day in the summer, or in a great temperature difference between inside and outside, inside air is moisturized on the rear window glass so that the visibility of a driver is considerably restricted.

FIG. 1 shows general circulation of interior air of an automobile and condensation of moisture on the rear window glass.

As shown in FIG. 1, the air with much moisture, exhaled during passengers' respiration, slowly circulates toward the rear window and then finally contacts to the rear window 10. The inside air is high humid on a damp day and further, it becomes more humid with passengers' respiration, thus resulting in an increased dew-point temperature.

At this time, the rear window is in contact with cold outside air, as compared with inside air, so that the temperature of the rear window is decreased due to heat transfer by the convection. Accordingly, the inside air contacted on the rear window starts to be condensed on the rear window as soon as it reaches lower than the dew-point temperature thus, finally restricting the rear visibility.

Until now, the conventional safety measures used for preventing moisture from being condensed on the rear window are as follows: 1) converting heater mode into defroster mode or fresh mode (i.e., exterior air inducing mode); 2) operating an air-conditioner; and 3) operating hot wires of the rear window to remove moisture around the hot wires.

Especially in the winter, the condensed moisture is frozen to be frost. It is more difficult to remove frost from the window by the hot wires. Further, the hot wire takes too much electric power as well as time to remove it.

In this regard, it is necessary to provide an apparatus for preventing moisture from being condensed on the rear window as a fundamental measure for prevention of frost.

### SUMMARY OF THE INVENTION

The present invention is contrived to solve the above-mentioned problems. An object of the present invention is to provide an apparatus that prevents moisture in inside air from being condensed on the rear window by collecting moisture which has polarity and moves downward on the rear window at a passage and then allowing the collected moisture to drain through the passage to the bottom of the rear window when the interior humidity of an automobile is above a predetermined limit, wherein the static-electricity generating means, selectively operated by both a humidity sensor and a switch, is mounted along the edges of the rear window, the passage is formed along the static-electricity generating means, and the humidity sensor is installed inside an automobile.

### BRIEF DESCRIPTION OF THE DRAWINGS

FIG. 1 is a schematic view showing general circulation of interior air and formation of dew on the rear window of an automobile.

FIG. 2 is a schematic diagram showing the components of the apparatus for preventing moisture on the rear window in accordance with the present invention.

FIG. 3 is an enlarged sectional view taken along line A-A of FIG. 2.

FIG. 4 is a perspective view showing the preferable place at which the humidity sensor is installed in accordance with the present invention.

FIG. 5 is a perspective view showing the flow of inside moisture in accordance with an embodiment of the present invention.

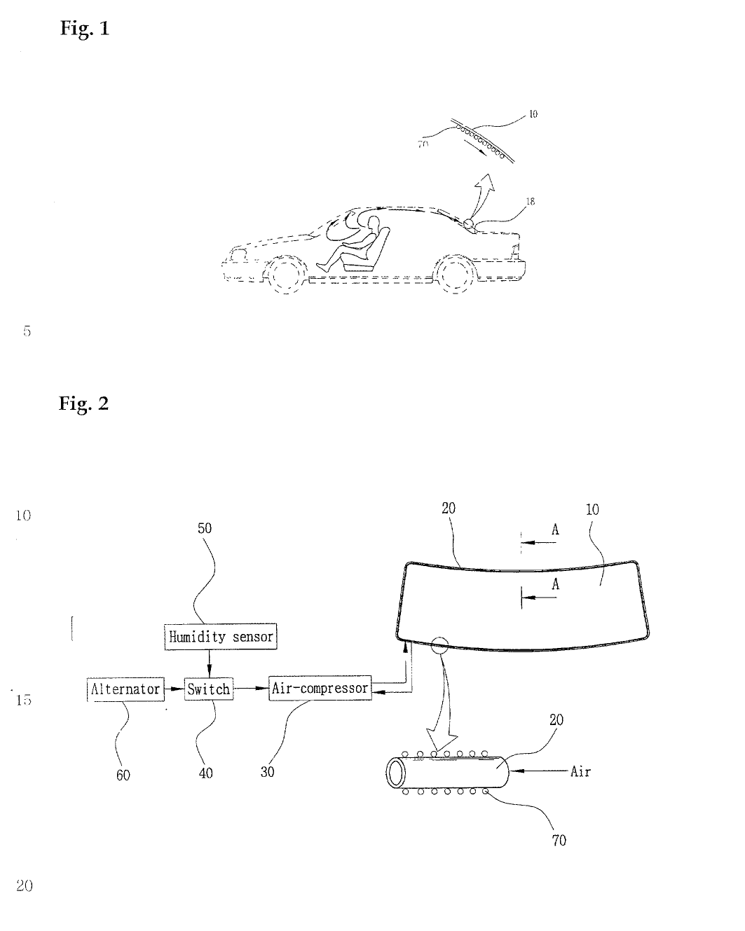

### DETAILED DESCRIPTION OF THE PREFERRED EMBODIMENTS

The present invention is described in detail with reference to the accompanying drawings as set forth hereunder.

The apparatus for preventing moisture on the rear window according to the present invention comprises:

a static-electricity generating means mounted between the rear window glass 10 and each of headlining 12 and rear pillar 14 as well as along the edges of the rear window 10;

a switch 40 installed at one side of body of an automobile and designated to supply selectively the electric current from an alternator 60; and

a humidity sensor 50 installed at one side inside an automobile and designated to turn the switch 40 on if the measured humidity exceeds a predetermined limit.

Said apparatus is characterized by collecting moisture, moving on the rear window glass 10, at a passage 16 which is formed along the static electricity generating means and then allowing the collected moisture to drain through the passage 16 to the bottom of the rear window glass 10.

The static-electricity generating means is a tube 20 electrified by passing air 22 at a high speed by operating air-compressor 60 into the tube 20.

The air-compressor 60 is further characterized by receiving selectively the electric current from the switch 40.

The passage 16 is still further characterized by being formed at a space between the rear window glass 10 and each of headlining 12 and rear pillar 14.

The present invention is described in more detail hereinafter.

Generally, water has polarity, which is resulted from the combination of oxygen atom and hydrogen atoms constituting water molecule. That is, the angle of combination of oxygen atom and hydrogen atoms is 104.5° and since the electronegativity of oxygen atom is higher than that of hydrogen atom, the covalent electron pair is more dense to the oxygen atom. Accordingly, the polarities, generated in water molecule, is not counterbalanced each other because oxygen atom has negative charge and hydrogen atom has positive charge.

In consequence, moisture particles, moving downward on the rear window glass 10 and having polarity, can be attracted to an electrified body.

Such characteristic of water molecule having polarity is applied to the apparatus of the present invention. The static-electricity generating means, mounted along the edges of the rear window glass 10, is electrified so that moisture particles of inside air can be attracted to the static-electricity generating means. Therefore, moisture can be collected at the passage 16 formed along the static-electricity generating means and then the collected moisture drains through the passage 16 to the bottom of the rear window glass 10.

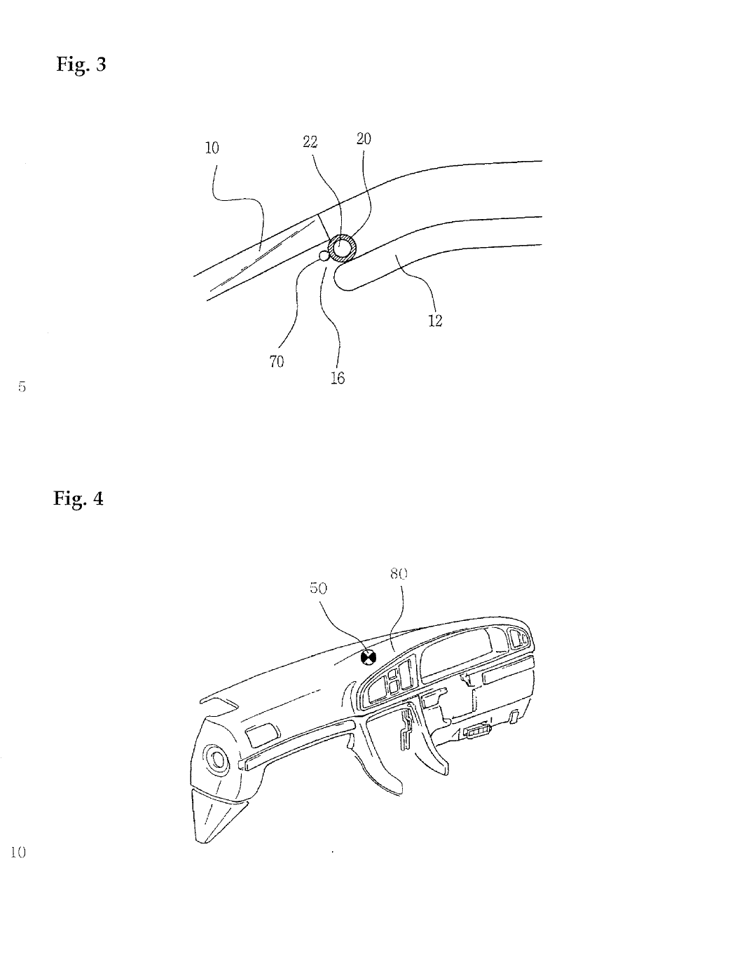

FIG. 2 is a schematic diagram showing the components of the apparatus according to the present invention. And FIG. 3 is an enlarged section view taken along line A-A of FIG. 2. A preferable embodiment of the present invention will be described as follows with reference to FIGS. 2-3.

As shown in FIGS. 2-3, the static-electricity generating means utilizes a tube 20 to electrify the outer surface of the tube 20 by passing air 22 at high speed into the tube 20, wherein the air at high speed is supplied from the air-compressor 60 into the tube 20.

As shown in FIG. 3, said tube 20 is made of the material such as PE or PVC which has a tendency to be easily electrified and is mounted between the rear window glass 10 and each of headlining 12 and rear pillar 14 as well as along the rear window 10. The outer surface of the tube 20 is electrified by passing air 22 at high speed into the tube 20. The passage 16 is formed at a space between the rear window glass 10 and each of headlining 12 and rear pillar 14.

The air 22 in high speed is supplied from an air-compressor 30 to one end of the tube 20 and then drained from the other end of tube 20, wherein the air-compressor 30 is actuated by the supply of the electric current from an existing alternator 60 mounted inside an automobile. The switch 40, installed between the alternator 60 and the air-compressor 30, selectively supplies the electric current to the air-compressor 30 by ON/OFF operation of the switch 40.

The switch 40 is controlled by the control signal from the humidity senor 50, thus opening or closing selectively the circuit between the alternator 60 and the air-compressor 30.

FIG. 4 shows the preferable place at which the humidity sensor 50 is installed according to the present invention.

The humidity sensor 50, which is capable of sensing the humidity of the air neighboring on the humidity sensor 50, should be properly installed at a place where accurately represents the overall interior humidity of an automobile. Preferably, the humidity sensor 50 is installed at the upper center portion of a crash pad 80.

The humidity sensor 50 turns the switch 40 on if the inside humidity exceeds a predetermined limit.

The other embodiment according to the present invention will be described with reference to FIGS. 2-4.

When the interior humidity is relatively high and the difference between interior and exterior temperatures is high, the air with much moisture, exhaled during passengers' breath, is slowly circulated from the front to the rear and then goes out between the rear window 10 and a rear package tray 18.

If the interior humidity exceeds a predetermined limit, the humidity sensor 50 transmits the control signal to the switch 40 and then the switch 40 is turned on so that the electric current can be supplied from the alternator 60 to the air-compressor 30.

Upon receiving the electric current from the alternator 60, the air-compressor 30 begins to supply air at high speed into the tube 20 mounted between the rear window glass 10 and each of the headlining 12 and the rear pillar 14.

The tube 20 is electrified by passing air 22 at high speed into the tube 20 so that the electrified tube 20 can attract moisture that has polarity and moves downward on the rear window glass 10.

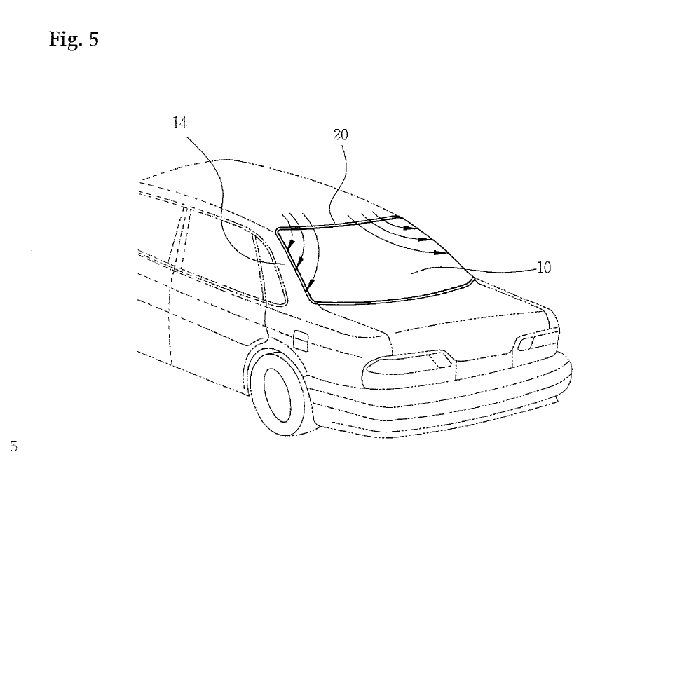

As shown in FIG. 5 that shows the flow of moisture in interior air according to the operation of the apparatus, moisture in interior air, moving downward on the rear window glass 10, is attracted to the edges of the rear window glass 10 by the electrified tube 20.

The collected moisture is condensed into dew at the passage 16 and then flows through the passage 16 to the bottom of the rear window glass 10.

In addition, since dust inside an automobile has polarity, dust can be also removed through the apparatus according to the present invention.

As described above, the apparatus according to the present invention prevents moisture from being condensed and frost from being formed on the rear window glass 10, thus securing a good rear visual range.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for preventing moisture on the rear window glass by collecting moisture in interior air, moving downward on the rear window glass 10, at a passage 16 and then allowing the collected moisture to drain to the bottom of the rear window glass 10 through the passage 16 which is formed along with said static electricity generating means, wherein the apparatus comprises:
a static-electricity generating means mounted between the rear window 10 and each of a headlining 12 and the rear pillar 14 as well as along the rear window 10;
a switch 40 installed at one side of body of an automobile and designated to supply selectively the electric current from an alternator 60; and
a humidity sensor 50 installed at one side inside an automobile and designated to turn the switch 40 on if the inside humidity exceeds a predetermined limit.

2. The apparatus for preventing moisture on the rear window glass according to the claim 1, wherein said static-electricity generating means is a tube 20 electrified by passing air 22 at a high speed by operating air-compressor 60 into the tube 20.

3. The apparatus for preventing moisture on the rear window glass according to the claim 2, wherein said air-compressor 60 selectively receives the electric current from the switch 40.

4. The apparatus for preventing moisture on the rear window glass according to the claim 1, wherein said passage 16 is a space between the rear window 10 and each of the headlining 12 and the rear pillar 14.
